(19) United States
(12) Patent Application Publication
(10) Pub. No.: US 2013/0140828 A1
(43) Pub. Date: Jun. 6, 2013

(54) WIND POWER GENERATOR AND VENTILATION STRUCTURE OF THE SAME

(71) Applicants: Kyungmin Ko, Geoje-si (KR); Tae Won Yoon, Geoje-si (KR); Samsang Kwon, Geoje-si (KR); Chunsik Lee, Geoje-si (KR)

(72) Inventors: Kyungmin Ko, Geoje-si (KR); Tae Won Yoon, Geoje-si (KR); Samsang Kwon, Geoje-si (KR); Chunsik Lee, Geoje-si (KR)

(73) Assignee: SAMSUNG HEAVY IND. CO., LTD., Seoul (KR)

(21) Appl. No.: 13/810,647

(22) PCT Filed: Aug. 26, 2011
(86) PCT No.: PCT/KR11/06344

§ 371 Date: Jan. 16, 2013

(30) Foreign Application Priority Data
Aug. 27, 2010 (KR) 10-2010-0083578

(51) Int. Cl. F03D 11/00

(52) U.S. Cl. CPC F03D 11/00
USPC 290/55

(57) ABSTRACT

A wind power generator is provided. The wind power generator includes a hub in which rotor blades are installed, a driver, in which the hub is rotatably installed, for transmitting torque received from the hub, and a nacelle including a generator for generating electricity using the torque received from the driver. The hub is rotatably installed in the nacelle by a main shaft on one side of which a flange connected to the hub is formed and on the other side of which a rotating body connected to the driver is formed. Air flow holes through which air may flow from the inside of the hub to the inside of the nacelle are formed in the flange of the main shaft.

### TECHNICAL FIELD

The present invention relates to a wind power generator, and more particularly, to the ventilation structure of a wind power generator.

### BACKGROUND ART

A wind power generator 1 that generates electricity using wind power that is natural energy includes a nacelle 3 installed on a tower 2, a hub 4 installed in the front of the nacelle 3, and rotor blades 5 installed in the hub 4 as illustrated in FIG. 1.

The nacelle 3 is connected to the hub by a main shaft formed to rotate while being integrated with the hub 4. In the nacelle 3, a gearbox connected to the main shaft and a generator driven by the shaft output of the gearbox are installed.

In the conventional wind power generator, in the hub 4 that rotates in the front of the nacelle 3 that is a fixed structure, an internal device that emits heat is installed. The internal device as a pitch control apparatus for rapidly and minutely changing the wing pitch of the blades 5 in accordance with a change in wind speed may include a driving device such as a hydraulic pump driven by a motor or a control device such as a control panel for controlling pitch.

On the other hand, the gearbox and the generator installed in the nacelle 3 are structured to emit heat when the wind power generator is driven.

At this time, the nacelle 3 and the hub 4 are structurally connected by a main shaft. However, since the hub 4 is closed, air flow between the nacelle 3 and the hub 4 is hardly generated.

In addition, it is necessary to close and seal the inside of the hub 4 in order to protect the internal device positioned in the hub 4. Therefore, since air flow hardly exists between the hub 4 and the nacelle 3, most of the air whose temperature rises due to heat emission in the hub 4 remains in the hub.

As described above, since the inside of the hub 4 is closed and sealed so that the hub 4 is easily filled with heat, there is a problem in that the temperature of the inside of the hub remarkably rises due to an increase in the amount of heat emission of the internal device.

Therefore, in order to normally drive the control device in the hub 4 to continuously generate electricity, it is necessary to develop a wind power generator having a ventilation structure in which the inside of the hub 4 may be easily cooled.

The above information disclosed in this Background section is only for enhancement of understanding of the background of the invention and therefore it may contain information that does not form the prior art that is already known in this country to a person of ordinary skill in the art.

### DISCLOSURE

### Technical Problem

An exemplary embodiment of the present invention provides a wind power generator having a ventilation structure capable of easily cooling the inside of a hub.

An exemplary embodiment of the present invention provides a wind power generator including an air flow path connected from the front of a hub to the rear of a nacelle through the inside of the hub and the inside of the nacelle.

### Technical Solution

According to an aspect of the present invention, in a wind power generator including a hub in which rotor blades are installed, a driver, in which the hub is rotatably installed, for transmitting torque received from the hub, and a nacelle including a generator for generating electricity using the torque received from the driver, the hub is rotatably installed in the nacelle by a main shaft on one side of which a flange connected to the hub is formed and on the other side of which a rotating body connected to the driver is formed and air flow holes through which air may flow from the inside of the hub to the inside of the nacelle are formed in the flange of the main shaft.

At this time, through-holes connected to the air flow holes so that air may flow may be formed on one side of the hub.

At this time, the main shaft may include a plurality of bolt combination holes formed along the circumference of the flange. A hollow space bolt may be installed in at least one of the plurality of bolt combination holes. The air flow hole may be a hollow space bolt hole formed in the hollow space bolt.

At this time, an electric wiring for connecting an electronic device installed in the hub and an electronic device formed in the nacelle to each other may pass through the hollow space bolt hole of the hollow space bolt.

At this time, a hub door may be installed in the front of the hub and a first air flow path for connecting the outside of the hub and the inside of the hub to each other so that air may flow may be installed in the hub door.

At this time, a second air flow path for connecting the inside of the nacelle and the outside of the nacelle to each other so that air may flow may be installed in the nacelle.

According to another aspect of the present invention, a ventilation structure of the wind power generator in which the inside of the hub and the inside of the nacelle are connected to each other through at least one of the air flow holes and hollow space of the main shaft so that air may flow is provided.

### Advantageous Effects

According to an exemplary embodiment of the present invention, the air flow holes are formed in the flange of the main shaft installed between the hub and the nacelle of the wind power generator so that air between the hub and the nacelle may flow.

At this time, according to an exemplary embodiment of the present invention, the hollow space bolts are combined with the bolt combination holes of the main shaft so that the hollow space bolt holes of the hollow space bolts may be used as the air flow holes or the paths through which the electric wiring installed between the hub and the nacelle passes.

### Advantageous Effects

According to an exemplary embodiment of the present invention, the ventilation structure in which the air flow paths are formed on one side of each of the hub door of the hub and the nacelle so that air may flow from the front of the hub to the outside of the nacelle through the inside of the hub and the inside of the nacelle is formed so that air may easily circulate in the hub and the nacelle of the wind power generator.

### DESCRIPTION OF THE DRAWINGS

FIG. 1 is a schematic diagram of a wind power generator.

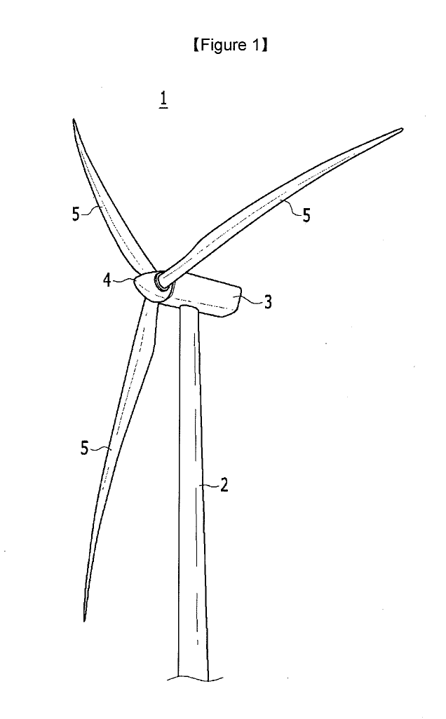

FIG. 2 is a perspective view illustrating a combination structure of the hub and the main shaft of a wind power generator according to an exemplary embodiment of the present invention.

FIG. 3 is a perspective view of the main shaft used for the wind power generator according to an exemplary embodiment of the present invention.

FIG. 4 is a perspective view of a hollow space bolt combined with the main shaft of the wind power generator according to an exemplary embodiment of the present invention.

FIG. 5 is a cross-sectional view of FIG. 2.

FIG. 6 is an enlarged view of VI in FIG. 5.

FIG. 7 is a drawing illustrating an air flow path in the hub and the nacelle of the wind power generator according to an exemplary embodiment of the present invention.

### MODE FOR INVENTION

Hereinafter, exemplary embodiments of the present invention will be described in detail with reference to the accompanying drawings so that a person of ordinary skill in the art may easily perform the present invention. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

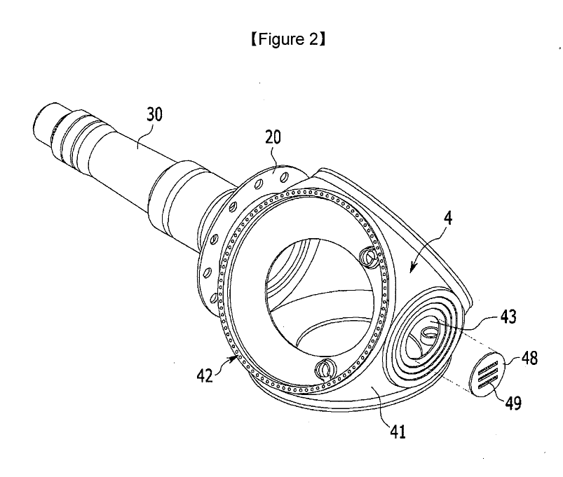

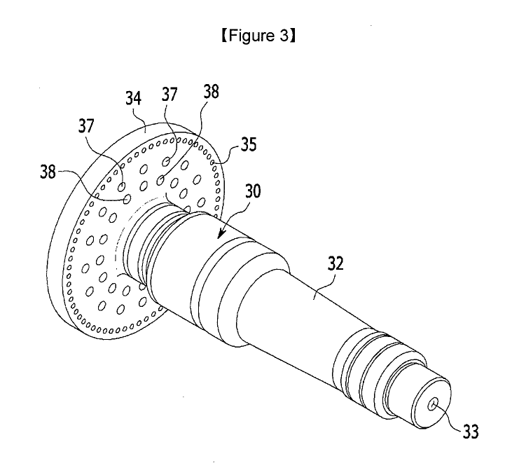

FIG. 2 is a perspective view illustrating a combination structure of the hub and the main shaft of a wind power generator according to an exemplary embodiment of the present invention. FIG. 3 is a perspective view of the main shaft used for the wind power generator according to an exemplary embodiment of the present invention. Hereinafter, in describing the wind power generator according to an exemplary embodiment of the present invention with reference to the drawings, the front is defined as meaning the direction in which the hub of the wind power generator is positioned so that wind blows from and the rear is defined as meaning the direction in which the nacelle of the wind power generator is positioned so that wind blows away.

The wind power generator according to an exemplary embodiment of the present invention includes an air flow hole in a flange 34 formed in a main shaft 30 connected to a hub 4 so that the inside of the hub 4 and the inside of a nacelle 3 may be connected so that air may flow.

At this time, according to the present exemplary embodiment, the air flow hole formed in the flange 34 of the main shaft 30 may consist of a plurality of holes 37 and 38 formed through the flange. In addition, according to an exemplary embodiment of the present invention, a hollow space bolt 10 is installed in at least one of a plurality of bolt combination holes 35. At this time, a hollow space bolt hole 15 formed in the hollow space bolt may form the air flow hole.

In a ventilation structure of the wind power generator according to an exemplary embodiment of the present invention, a plurality of holes are formed in the flange of the main shaft or the hollow space bolts 10 are installed in the bolt combination holes so that the hub and the nacelle may be connected so that air may flow.

Hereinafter, the structure of the main shaft including the air flow hole and the ventilation structure of the wind power generator according to an exemplary embodiment of the present invention will be described in detail with reference to the drawings.

Referring to FIG. 2, the hub 4 of the wind power generator according to an exemplary embodiment of the present invention includes a hub body 41 including a hub door opening 43 in the front of which a hub door 48 is installed.

The hub door 48 is installed in the hub door opening 43 and a first air flow path 49 is formed in the hub door 48. The first air flow path 49 is a structure for letting air flows from the outside of the hub to the inside of the hub.

At this time, the first air flow path 49 may adopt a structure such as a louver so that air passes through the first air flow path 49 and that an alien material such as rainwater is not flown to the inside of the hub.

At this time, a fan may be installed in the first air flow path 49 so air flow may be forcibly performed. A plurality of blade combination holes 42 with which rotor blades 5 are combined are formed on the side of the hub body 41.

A main shaft combination hole 44 is formed in the rear of the hub body 41 so that the main shaft 30 may be combined with the rear of the hub body 41.

Referring to FIG. 3, the main shaft 30 combined with the hub body 41 includes a cylindrical rotating body 32 and the flange 34 formed in the front of the rotating body 32.

A hollow space 33 is formed in the rotating body 32 in the center of a rotating shaft in a shaft direction.

The flange 34 having a radius larger than the rotating body is formed in the front of the rotating body. At this time, a plurality of bolt combination holes 35 are formed in the external circumference of the flange 34 to be separated from each other at uniform intervals.

On the other hand, a plurality of bolt combination through-holes 46 are formed in the rear of the hub body 41 to correspond to the bolt combination holes 35.

In the conventional art, stud bolts are combined with the bolt combination holes of the flange and the bolt combination through-holes of the hub body so that the hub and the main shaft are combined with each other. In the conventional art, when the electronic device in the hub of the wind power generator is electrically connected to the electronic device in the nacelle, an electric wiring is disposed in the hollow space of the main shaft so that the hollow space is used as an electric wiring path.

However, in the present exemplary embodiment, as an exemplary embodiment, the hollow space bolts 10 instead of the conventionally used stud bolts are combined with the bolt combination holes 35 formed in the flange 34 of the main shaft 30 and the bolt combination through holes 46 of the hub body 41. At this time, the hollow space bolt 10 may be a hollow space stud bolt.

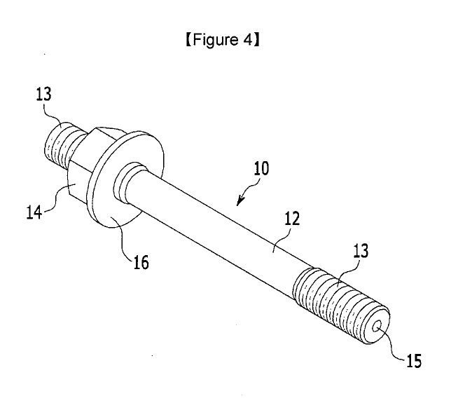

FIG. 4 illustrates the hollow space bolt 10 used for the wind power generator according to the present exemplary embodiment.

Referring to FIG. 4, in the hollow space bolt 10 used in the present exemplary embodiment, screw threads 13 are formed at both ends of a cylindrical hollow space bolt body 12 and the hollow space bolt hole 15 is formed in the center in a longitudinal direction. On the other hand, constituent elements such as a nut 14 and a washer 16 may be combined with the screw thread 13 of the hollow space bolt 10.

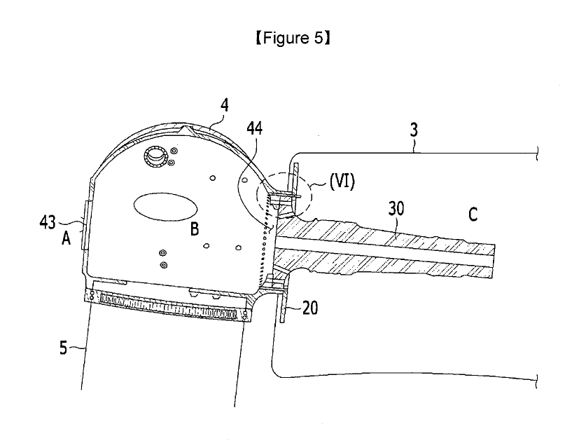

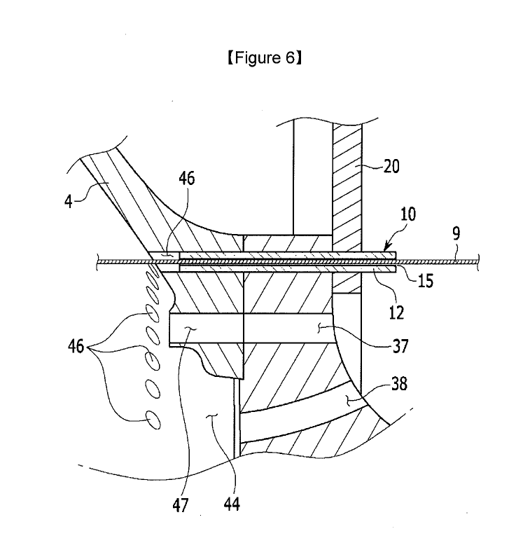

FIG. 5 is a cross-sectional view of the state in which the hub 4 and the main shaft 30 are combined with each other. FIG. 6 is an enlarged cross-sectional view of VI of FIG. 5.

Referring to FIG. 5, in the wind power generator 1 according to an exemplary embodiment of the present invention, the hub 4 of the wind power generator 1 and the flange 34 of the main shaft 30 are combined with each other by the plurality of hollow space bolts 10.

At this time, the plurality of, for example, 76 bolt combination through-holes 46 and bolt combination holes 35 are formed in each of the hub 4 and the flange 34 of the main shaft 30. In the present exemplary embodiment, at least parts of the stud bolts combined with the bolt combination through-holes 46 and the bolt combination holes 35 are formed of the hollow space bolts 10 including the hollow space bolt holes.

At this time, the hollow space bolts 10 may be combined with the entire bolt combination through-holes 46 and bolt combination holes 35. However, if necessary, the hollow space stud bolts may be combined with parts of the bolt combination through-holes 46 and the bolt combination holes 35 and common stud bolts that do not have hollow spaces may be combined with the remaining bolt combination through-holes 46 and bolt combination holes 35.

According to an exemplary embodiment of the present invention, spaces in which air may flow are formed between the hub 4 and the nacelle 3 by the size of the hollow space bolt holes×the number of installed hollow space bolts 10 for combining the hub 4 and the main shaft 30 with each other. In this case, in the wind power generator according to an exemplary embodiment of the present invention, the hollow space bolt hole 15 may be used as an air flow path through which air in the hub may flow to the inside of the nacelle 3.

On the other hand, according to an exemplary embodiment of the present invention, the hollow space bolt hole 15 may be used as a wiring installing space in which a wiring 9 of the electronic device positioned in the hub 4 may be extended to the inside of the nacelle 3.

That is, in the conventional art, the electric wiring may be installed from the inside of the hub to the inside of the nacelle only in the hollow space of the main shaft and the remaining parts are closed by the flange of the main shaft. In addition, when the electric wiring is installed in the hollow space of the main shaft, since the hollow space is narrowed by the electric wiring, the air flow path through which air may flow from the inside of the hub to the inside of the nacelle hardly exists.

However, like in the present exemplary embodiment, when the hollow space bolt 10 is used in order to combine the hub 4 and the main shaft 30 with each other, the hollow space bolt hole 15 of the hollow space bolt 10 may be used as the electric wiring installing space.

When the hollow space bolt hole 15 is used as the electric wiring installing space, since it is not necessary to install the electric wiring 9 in the hollow space 33 of the main shaft 30, the hollow space 33 is empty so that the hollow space 33 may function as the air flow path.

At this time, it may be considered to install the electric wiring in the space in which the electric wiring may be easily installed between the hollow space 33 and the hollow space bolt hole 15 of the hollow space bolt.

On the other hand, according to an exemplary embodiment of the present invention, the air flow holes 37 and 38 may be formed on one side of the flange 34 of the main shaft regardless of the hollow space bolt being installed. Referring to FIGS. 3, 5, and 6, the air flow holes 37 and 38 may be formed to be closer to the center of the main shaft than the bolt combination holes 35 of the flange. The air flow holes denoted by reference numeral 37 are different from the air flow holes 38 denoted by reference numeral 38 in that through-holes 47 of the hub are positioned on the side of the air flow holes denoted by reference numeral 37.

In detail, the through-holes 47 are formed in the hub 4 to run parallel with the air flow holes denoted by reference numeral 37 so that air in the hub 4 may flow to the inside of the nacelle 3 through the through-holes and the air flow holes 37.

The air flow holes denoted by reference numeral 38 are formed to be connected to main shaft combination holes 44 so that air may directly flow to the inside of the hub and the inside of the nacelle without additionally forming through-holes in the hub.

As described above, according to an exemplary embodiment of the present invention, when the hollow space bolts are not combined with the bolt combination holes and additional air flow holes are formed in the flange, air flow paths as wide as the corresponding air flow holes may be generated.

As described above, the air flow holes 37 and 38 formed in the flange of the main shaft may be used as the air flow paths through which air flows from the inside of the hub 4 to the inside of the nacelle 3.

At this time, the air flow holes 47 and 37 may be formed to have the position and size suitable for the connection part between the hub 4 and the main shaft 30 in a range that does not weaken the connection strength between the hub 4 and the main shaft 30.

As described above, when the air flow holes 47 and 37 are formed between the hub 4 and the nacelle 3, an area in which air may flow between the hub 4 and the nacelle 3 increases.

In the wind power generator having the above structure, air may be flown from the front of the wind power generator 1 to the rear of the nacelle 3 through at least one of the hollow space 33 of the main shaft, the air flow holes 37 and 38, and the hollow space bolt holes 15 of the hollow space bolts combined with the bolt combination holes.

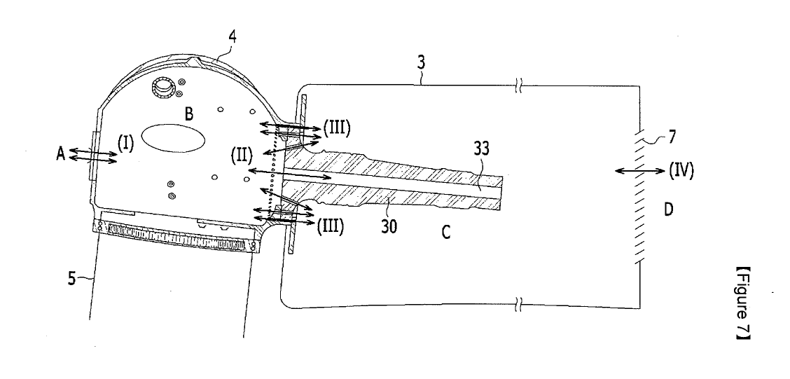

FIG. 7 illustrates a ventilation structure in which air flows through the hub 4 and the nacelle 3 of the wind power generator 1 according to an exemplary embodiment of the present invention.

Referring to FIG. 7, in the wind power generator 1 according to an exemplary embodiment of the present invention, air positioned in the front A of the wind power generator 1 is flown to the inside B of the hub through the first air flow path 49 formed in the hub door 48 (air flow in the direction of arrows (I)).

Air flown to the inside B of the hub may move from the inside (B) of the hub to the inside C of the nacelle through two paths, that is, the hollow space 33 of the main shaft 30 (air flow in the direction of an arrow (II)) and the hollow space bolt holes 15 to be formed in the plurality of hollow space bolts for combining the hub 4 and the main shaft 30 with each other or the air flow holes 37 and 38 (air flow in the direction of arrows (III)).

At this time, when at least one of the air flow holes 37 and 38 and the hollow space bolt holes 15 is formed, air may flow from the inside of the hub to the inside of the nacelle.

On the other hand, air moved to the inside (C) of the nacelle may be discharged to the rear (D) of the nacelle 3 through a second air flow path 7 installed in the rear of the nacelle, for example, a ventilation hole that may be in the form of the louver (air flow in the direction of an arrow (IV))

In the present exemplary embodiment, the second air flow path 7 is formed in the rear of the nacelle 3. However, the second air flow path 7 may be positioned anywhere so long as air in the nacelle 3 is discharged to the outside.

When a fan is installed in the hub door 48, air flow is forcibly performed so that air may flow from the front of the wind power generator to the rear of the nacelle through the inside (B) of the hub and the inside (C) of the nacelle.

While this invention has been described in connection with what is presently considered to be practical exemplary embodiments, it is to be understood by a person of an ordinary skill in the art that the invention is not limited to the disclosed embodiments, but, on the contrary, is intended to cover various modifications and equivalent arrangements included within the spirit and scope of the appended claims by adding, changing, and adding constituent elements.

In the wind power generator according to an exemplary embodiment of the present invention, as described above, the electronic devices in the hub and the nacelle may be easily cooled by opened air flow through the hub and the nacelle.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A wind power generator including a hub in which rotor blades are installed, a driver, in which the hub is rotatably installed, for transmitting torque received from the hub, and a nacelle including a generator for generating electricity using the torque received from the driver,
wherein the hub is rotatably installed in the nacelle by a main shaft on one side of which a flange connected to the hub is formed and on the other side of which a rotating body connected to the driver is formed, and
wherein air flow holes through which air may flow from the inside of the hub to the inside of the nacelle are formed in the flange of the main shaft.

2. The wind power generator of claim 1, wherein through-holes connected to the air flow holes so that air may flow are formed on one side of the hub.

3. The wind power generator of claim 1, wherein the main shaft comprises a plurality of bolt combination holes formed along the circumference of the flange,
wherein a hollow space bolt is installed in at least one of the plurality of bolt combination holes, and
wherein the air flow hole is a hollow space bolt hole formed in the hollow space bolt.

4. The wind power generator of claim 3, wherein an electric wiring for connecting an electronic device installed in the hub and an electronic device formed in the nacelle to each other passes through the hollow space bolt hole of the hollow space bolt.

5. The wind power generator of claim 1, wherein a hub door is installed in the front of the hub, and wherein a first air flow path for connecting the outside of the hub and the inside of the hub to each other so that air may flow is installed in the hub door.

6. The wind power generator of claim 5, wherein a second air flow path for connecting the inside of the nacelle and the outside of the nacelle to each other so that air may flow is installed in the nacelle.

7. A ventilation structure of the wind power generator of claim 1,
wherein the inside of the hub and the inside of the nacelle are connected to each other through at least one of the air flow holes and a hollow space of the main shaft so that air may flow.
